(19) United States
(12) Patent Application Publication
(10) Pub. No.: US 2022/0022529 A1
(43) Pub. Date: Jan. 27, 2022

(54) Paper Sheet and Method of Making It

(71) Applicant: Schweitzer-Mauduit International, Inc., Alpharetta, GA (US)

(72) Inventors: Jiayi Pan, Spay (FR); Patrick Guilchet, Spay (FR)

(21) Appl. No.: 17/299,902

(22) PCT Filed: Dec. 6, 2019
(86) PCT No.: PCT/EP2019/084041

§ 371 Date: Jun. 4, 2021

(30) Foreign Application Priority Data
Dec. 7, 2018 (EP) 18306639.8

(51) Int. Cl. A24D 3/10; A24D 3/06; A24D 1/02; D21H 13/08; D21F 11/00; D21H 13/14; D21H 13/16; D21H 13/18; D21H 13/24; D21H 13/22; D21H 27/08

(52) U.S. Cl. CPC A24D 3/10; A24D 3/068; A24D 1/02; D21H 13/08; D21F 11/00; D21H 27/08; D21H 13/16; D21H 13/18; D21H 13/24; D21H 13/22; D21H 13/14

(57) ABSTRACT

The present invention relates to a biodegradable paper sheet for filter element comprising refined cellulose fibers and hydrophobic fibers.

The present invention relates to a biodegradable paper sheet.

Smoking articles such as cigarettes are conventionally made by wrapping a column of tobacco in cigarette paper. At one end, the smoking article usually includes a filter element through which the smoke generated by the combustion of the tobacco rod passes. The filter element is attached to a smoking article using tipping paper which is glued to the wrapping paper.

Although there are some exceptions, conventional filter elements are typically formed from cellulose acetate tows. Filters made with cellulose acetate however biodegrade very slowly. The slow rate of biodegradation of cellulose acetate is particularly troubling since the filter is not consumed during use of the tobacco product. Consequently, discarded filter element are commonly found in the environment, especially outside buildings and along roadways.

In view of the above, those skilled in the art have attempted to replace cellulose acetate with other materials. For instance, in U.S. Pat. No. 5,360,023, a filter element for a cigarette is disclosed formed from a gathered web of paper that incorporates a carbonaceous material. GB 2075328 discloses a tobacco smoke filter element comprising a corrugated and/or fibrillated web of paper gathered laterally in rod form.

Those skilled in the art know that the use of paper media as a filter for smoking articles can provide numerous advantages. For instance, paper filter element quickly biodegrades and the filtration properties of a paper filter element can be varied and controlled. Unfortunately, paper filter element presents a number of drawbacks. For instance, paper filter element can generate smoke having dry taste and being astringent, bitter harsh and/or irritating. In addition, it may be less efficient in trapping certain smoke constituents. This is believed to result from the strong hydrophilic behavior of paper. These smoke constituents include phenols (such as phenol, cresol and/or resorcinol), some acids, some aldehydes (such as crotonaldehyde), some ketones, some esters, some alcohols, some amides, and some pyrroles. In addition, paper filter element has a tendency to absorb smoke components to a different degree than cellulose acetate which may result in smoke having a burnt paper taste. US 2015/001148 discloses a paper filter element comprising a base web containing cellulose fibers coated with hydrophobic additives that quickly biodegrades. The filtration properties of the paper filter element of US 2015/001148 are better than the ones of classical paper filter elements; however they are not completely satisfactory.

In view of the above, a need exists for a paper sheet for a filter element for a smoking article or tobacco heat-not-burn stick that degrades sufficiently quickly, filtrates efficiently certain smoke constituents and produces a smoke having a comparable sensory profile to cellulose acetate filter.

The inventors have developed a paper sheet comprising cellulose fibers and hydrophobic fibers suitable to be used as a biodegradable material with acceptable filtration efficiency and sensory properties with respect to cellulose acetate filter element.

The present invention describes a paper sheet comprising cellulose fibers and hydrophobic fibers, wherein the cellulose fibers represent 10% to 90% by weight of the dry matter of the paper sheet, the hydrophobic fibers represent 10% to 90% by weight of the dry matter of the paper sheet and the cellulose fibers and the hydrophobic fibers represent at least 50% by weight of the dry matter of the paper sheet.

Advantageously, the paper sheet of the present invention is biodegradable. Moreover the paper sheet of the present invention can be easily produced by a paper making process and has improved paper making and filter making machinability.

As used in the present specification, the term “hydrophobic” refers to a material or suface exhibiting water repelling properties. As will be described in greater detailed below, one useful way to determine this is to measure the water contact angle. The “water contact angle” is the angle, conventionally measured through the liquid, where a liquid/vapour interface meets a solid surface. This angle substantially quantifies the wettability of a solid surface by a liquid as described by the Young equation.

As used in the present specification, the expression “cellulose fiber” refers to bleached or unbleached cellulosic plant fibers obtained by a chemical, mechanical or thermomechanical pulping process such as wood pulp or the pulp of annual plants such as flax or tobacco for example. The expression “cellulose fiber” may also intend to mean a mixture of these bleached or unbleached cellulosic plant fibers.

According to one particular embodiment, the weight ratio of hydrophobic fibers to cellulose fibers is 2:3 to 3:2, in particular 2:1 to 1:2, more particularly 1:1.

Let S_{vf}, the weight percentage of dry matter within the paper sheet of hydrophobic fibers, be S_{vf}min≤S_{vf}≤S_{vf}max, the percentage S_{vf}min and S_{vf}max are chosen independently of one another, S_{vf}min being chosen from the values 10%, 15%, 20%, 25%, 30%, 35%, 40%, 45%, and 50%, and S_{vf}max being chosen from the values 50%, 55%, 60%, 65%, 70%, 75%, 80%, 85% and 90%.

Preferably, S_{vf}min is chosen from the values 30%, 35%, 40%, 45% and 50% and S_{vf}max is chosen from the values 60%, 65%, 70%. Most preferably S_{vf} is around 50%.

Let S_{c}f, the weight percentage of dry matter within the paper sheet of cellulose fibers, be S_{cf}min ≤S_{cf}≤S_{cf}max, the percentage S_{cf}min and S_{cf}max are chosen independently of one another, S_{cf}min being chosen from the values 10%, 15%, 20%, 25%, 30%, 35%, 40%, 45%, and 50% and S_{cf}max being chosen from the values 50%, 55%, 60%, 65%, 70%, 75%, 80%, 85% and 90%. Preferably, Sfmin is equal to 25% and S_{cf}max is equal to 60%. Most preferably S_{cf} is around 50%.

Let S_{f}, the weight percentage of dry matter within the paper sheet of cellulose fibers and hydrophobic viscose, be S_{f}min≤S_{f}≤S_{f}max, the percentage S_{f}min and S_{f}max are chosen independently of one another, Sfmin being chosen from the values 55%, 60%, 65%, 70%, and 75%, and S_{f}max being chosen from the values 80%, 85%, 90%, 95%, 99% and 100%.

Preferably, S_{f}min is equal to 54% and Sfmax is equal to 99.5%. Most preferably S_{f} is around 95%.

According to one particular embodiment, S_{vf}min is 30%, 35%, 40%, 45% and 50% and S_{f}min is 70%.

According to this particular embodiment, the paper sheet of the present invention is hydrophobic. Advantageously a filter element made from an hydrophobic paper sheet has good filtration properties and produces a smoke having an acceptable taste to consumers.

Typically the capillary rise of the paper sheet according to this particular embodiment is below 10 mm/10 min, in particular below 5 mm/10 min, more particularly below 0.5 mm/10 min according to ISO 8787:1986.

Typically the time necessary for a drop of water to be absorbed by the paper sheet according to this particular embodiment is higher than 60 seconds, in particular higher than 120 seconds, more particularly higher than 180 seconds according to TAPPI T432 (1964).

Typically the water contact angle of the paper sheet according to this particular embodiment is higher than 70°, in particular is 75° to 140°, more particularly is 80° to 120°.

As used in the present specification, the water contact angle of the paper sheet is determined as follows:
for each face of the paper sheet, a water contact angle is first measured at a contact time of 0.1 s, 1 s and 10 s according to TAPPFANSI T 558 om-15 (2015),
these three measured water contact angles are then averaged to obtain an average for each face, and
the water contact angle of the paper sheet is determined by averaging the average for each face of the paper sheet.

Typically the titer of the hydrophobic fiber is 0.5 dtex to 40 dtex, in particular 1 dtex to 6 dtex, more particularly 1.7 dtex to 3.3 dtex.

Typically the length of the hydrophobic fibers is less than 20 mm, in particular 1 mm to 12 mm, more particularly 2 mm to 5 mm.

Advantageously, the paper sheet of the present invention can be more easily manufactured because the length of hydrophobic fibers is in the above ranges.

According to one embodiment, the hydrophobic fibers are hydrophobic viscose fibers.

As used in the present specification, the term “hydrophobic fiber” refers to a fiber exhibiting water repelling properties, said repelling properties being measured by a sinking test. The sinking test is the time until the fiber sinks in a specified amount of water. The time is typically less than 5 seconds for a viscose fiber that does not have repelling properties. The time is typically more than 24 hours for a hydrophobic viscose fiber.

Hydrophobic viscose fibers are described, for example, in US 2015/0329707. According to US 2015/039707, the hydrophobic viscose fiber is typically a resulting mixture of a viscose fiber and an hydrophobic substance selected from the group consisting of alkyl ketene dimers, alkenyl ketene dimers, alkyl succinic anhydrides, alkenyl succinic anhydrides, alkyl glutaric acid anhydrides, alkenyl glutaric acid anhydrides, alkyl isocyanates, alkenyl isocyanates, fatty acid anhydrides, and mixtures thereof, and the content of hydrophobic substance in the hydrophobic viscose fiber is 0.1% by weight to 13% by weight based on viscose fiber, in particular is from 1% by weight based on viscose fiber to 7.5% by weight based on viscose fiber.

An example of hydrophobic viscose fiber is the OLEA® viscose fiber of Kelheim Fibres GmbH.

Typically the diameter of the cellulose fibers is 0.015 mm to 0.045 mm, in particular 0.02 mm to 0.04 mm.

Typically the length of the cellulose fibers is less than 20 mm, in particular 1 mm to 12 mm, more particularly 2 mm to 5 mm.

Advantageously, the paper sheet of the present invention can be more easily manufactured because the length of the cellulose fibers is in the above ranges.

According to one embodiment, the cellulose fibers may be refined. Typically the refined cellulose fibers have a Shopper-Riegler degree (SR degree) of 9° SR to 90° SR, in particular of 10° SR to 40° SR, more particularly of 15° SR to 25° SR, even more particularly of 15° SR.

Advantageously, the refined cellulose fibers having a SR degree in the above ranges enable the paper sheet to have the tensile strength indicated below.

Typically, the SR degree is measured according to ISO 5267-1 (July 2000).

According to one embodiment, the paper sheet may further comprise a binding agent.

The binding agent may be chosen from polyvinyl alcohol (PVOH), ethylene vinyl alcohol (EVOH), polyvinyl acetate (PVA), polyethylene, polypropylene, polyester, cellulose acetate, cellulose ester, alkyl succinic anhydride, a rosin, an acrylic copolymer such as a styrene acrylic copolymer, a modified starch, an hydrocolloid such as a gelatin, and mixture thereof.

According to one embodiment the binding agent may have the shape of a fiber. Typically the binding agent having the shape of a fiber is chosen from polyvinyl alcohol (PVOH) fiber, polyvinyl acetate (PVA) fiber, polyethylene fiber, polypropylene fiber, polyester fiber, cellulose acetate fiber, nylon, cellulose ester fiber and mixture thereof.

Typically, the binding agent represents 20% or less by weight of the dry matter of the paper sheet of the present invention, in particular represents 5 to 15% by weight of the dry matter of the paper sheet of the present invention.

Advantageously the binding agent increases the tensile strengths, MD and CD, of the paper sheet of the present invention. Accordingly, the filter making machinability of the paper sheet of the present invention is further improved by the binding agent.

Moreover, the paper sheet comprising binding agent has generally a smoother surface that results in less friction.

According to one embodiment, the paper sheet may further comprise an additive.

Typically the additive represents less than 45% by weight of the dry matter of the paper sheet of the present invention, in particular 22% to 26%, by weight of the dry matter of the paper sheet of the present invention.
As described in US 2015/001148, the additive is typically chosen from a sizing agent, a humectant, a selective filtration agent and mixture thereof.

The sizing agent may be alkyl ketene dimer, alkenyl ketene dimer, alkenyl succinic anhydride, rozine and mixture thereof.

Typically the sizing agent represents less than 30% by weight of the dry matter of the paper sheet of the present invention, in particular 5% to 10%, by weight of the dry matter of the paper sheet of the present invention.

Advantageously the sizing agent may improve the hydrophobicity, the surface strength and the printability of the paper sheet of the present invention.

The humectant may be a polyether, such as polyalkylene glycol having an average molecular weight of greater than about 500 g/mol, in particular 500 g/mol to 3000 g/mol, more particularly 500 g/mol to 1000 g/mol. The humectant may also be monopropylene glycol, sorbitol, glycerine, triacetin, and mixture thereof. In one embodiment, the humectant may be a polyethylene glycol or polyethylene oxide or methoxypolyethylene glycol or PEG derivative.

Typically the humectant represents less than 30% by weight of the dry matter of the paper sheet of the present invention, in particular 5% to 25% by weight of the dry matter of the paper sheet of the present invention, more particularly 15% to 20% by weight of the dry matter of the paper sheet of the present invention.

Typically the selective filtration agent is an amino acid or an amino acid salt, in particular a basic amino acid or basic amino acid salt, and a combination of them. According to a particular embodiment, the selective filtration agent may be a polyethyleneimine, a polyurea, a polyamide, a functionalized fiber or filler with amino groups.

According to one embodiment, the amino acid may be glycinate. The glycinate may be in a basic form and may comprise an alkaline glycinate, such as sodium glycinate. Other amino acids or peptides (chains of amino acids) that may be used include amino acids with hydrophobic side chains such as alanine, valine, isoleucine, leucine, phenylalanine; amino acids with electrically charged side chains such as lysine, arginine, glutamic acid; amino acids with uncharged side chains such as glutamine, serine; non proteic amino acids such as citrulline, ornithine; and any other suitable peptides or protein extracts. These amino acids can also be in alkaline form, mixtures thereof, and the like.

According to another embodiment, in order to use an amino acid in its basic form, the amino acid may comprise a salt that has been reacted with an alkaline metal or an alkaline earth metal.

Typically the selective filtration agent represents less than 30% by weight of the dry matter of the paper sheet of the present invention, in particular 10% to 20% by weight of the dry matter of the paper sheet of the present invention.

A filter element made of the paper sheet of the present invention comprising a selective filtration agent can also selectively remove various constituents from the mainstream smoke and improve smoke taste. For instance, various smoke toxicants that may be present in the mainstream smoke, particularly phenolic compounds and/or carbonyls can be removed. For instance, phenolic compounds that may be selectively removed from the mainstream smoke by the filter element may include phenol, cresol, and the like.

Advantageously, the kinetic of biodegradation of the paper sheet of the present invention may be accelerated by the additives.

According to a specific embodiment, a paper sheet of the present invention may comprise from 37% to 39% of refined cellulose fibers, from 37% to 39% of hydrophobic viscose fibers, from 7% to 8% of sizing agent and from 15% to 18% of humectant (% being by weight of the dry matter of the paper sheet of the present invention).

According to another specific embodiment, a paper sheet of the present invention may comprise from 27% to 29% of cellulose fibers, from 27% to 29% of hydrophobic viscose fibers, from 15 to 25% of binding agent, from 7% to 8% of sizing agent and from 15% to 18% of humectant (% being by weight of the dry matter of the paper sheet of the present invention).

Typically the tensile strength MD (Machine Direction) of the paper sheet of the present invention is above 1500 cN/30 mm, in particular 2000 cN/30 mm to 3500 cN/30 mm, more particularly 2510 cN/30 mm to 3200 cN/30 mm.

Typically the tensile strength CD (Cross-Machine Direction) of the paper sheet of the present invention is above 100 cN/30 mm, in particular 500 cN/30 mm to 2000 cN/30 mm, more particularly 900 cN/30 mm to 1750 cN/30 mm.

The tensile strength is measured according to ISO 1924-2 (December 2008), except that:
the speed which is 10 mm/min (in Machine Direction) and is 30 mm/min (in Cross-Machine Direction) and not 20 mm/min (in Machine Direction and in Cross-Machine Direction),
the width of the tested sample is 30 mm and not 15 mm.

Advantageously, the paper sheet of the present invention has an improved filter making machinability since it has the above tensile strengths.

Typically the basis weight of the paper sheet of the present invention is 15 g·m⁻² to 60 g·m⁻², in particular 20 g·m⁻² to 50 g·m⁻², more particularly 25 g·m⁻² to 40 g·m⁻².

Typically the porosity of the paper sheet of the present invention is 1000 CORESTA units to 50000 CORESTA units, in particular 5000 CORESTA units to 40000 CORESTA units, more particularly 10000 CORESTA units to 35000 CORESTA units. The porosity is measured according to ISO 2965:2009.

Typically the thickness of the paper sheet of the present invention is 0.025 mm to 0.2 mm, in particular 0.05 mm to 0.175 mm, more particularly 0.07 mm to about 0.16 mm.

Due to its physical properties, the paper sheet of the present invention is advantageously adapted to be used as in filter element, in particular a filter element of a combusted cigarette, a tobacco heat-not-burn stick, or any product burnt or heated intended to generate an aerosol to be inhaled. Indeed, a filter element made from the paper sheet of the present invention has good filtration properties and produces a smoke having an acceptable taste to consumers.

Accordingly the paper sheet of the present invention can be used as a filter element, in particular a filter element of a combusted cigarette, a tobacco heat-not-burn stick, or any product burnt or heated intended to generate an aerosol to be inhaled.

Accordingly the present disclosure also relates to a filter material comprising the paper sheet of the present invention as defined above.

One embodiment relates to a papermaking process for manufacturing the paper sheet of the present invention as defined above comprising the following steps:
a) mixing the cellulose fibers, hydrophobic fibers and water to obtain an aqueous slurry;
b) forming the aqueous slurry into a wet paper on an inclined wire paper machine or flat wire paper machine, and
c) drying the wet paper to obtain the paper sheet.

The skilled person knows how to adapt the papermaking process of the present invention for manufacturing the paper sheet of the present invention as defined above.

During step a) the cellulose fibers and the hydrophobic fibers are conventionally mixed with water.

During step b) the aqueous slurry is deposited onto a porous forming surface of the flat wire paper machine or of the inclined wire paper machine, in particular onto a porous forming surface of the inclined wire paper machine. The porous forming surface allows water to drain thereby forming the wet paper.

According to one embodiment, the porous forming surface may include a woven pattern that incorporates texture into the wet paper as it is being formed.

During step c), the wet paper is dried at a temperature of 60° C. to 175° C., in particular of 70° C. to 150° C., more particularly of 80° C. to 130° C.

If the paper sheet of the present invention comprises refined cellulose fibers, the cellulose fibers are refined, before step a), so as to have a SR degree of 9° SR to 90° SR, in particular of 10° SR to 40° SR, more particularly of 15° SR.

Typically the cellulose fibers are refined using classical refining process and classical refiner for paper pulp such as disc refiners, conical refiners, and the like.

The skilled person knows how to adapt the refining process and the refiner so that the refined cellulose fibers have the above mentioned SR degree.

If the paper sheet of the present invention comprises a binding agent as defined above, the binding agent is added to the aqueous slurry during or after step a) or is applied to one surface or to both surfaces of the papers after step b) or step c), i.e. to the wet paper after step b) or to the paper sheet after step c).

Typically, the binding agent having a shape of fiber is added to the aqueous slurry during step a).

The skilled person knows that the binding agent having a shape of fiber added to the aqueous slurry during step a) may melt during the drying step c) and lose its shape of fiber.

Any suitable technique may be used to apply the binding agent to the papers. For instance, the binding agent may be applied by size press, spraying, knife coating, Meyer rod coating, dusting, transfer roll coater or through any suitable printing process. Printing processes that may be used include flexographic printing, gravure printing, and the like. In one embodiment, the binding agent may cover 100% of the surface area of one side or both sides of the papers.

In one embodiment, the binding agent can be printed on one or both sides of the papers. The pattern may comprise alternating lines or alternating squares such as a checkerboard. In this manner, less binding agent is used to coat the papers while still retaining all the benefits. For instance, the binding agent may be applied to one surface of the papers so as to cover 10% to 100% surface area of the paper, in particular 20% to 90% of the surface area of the papers, more particularly 40% to 60% of the surface area of the papers. In another embodiment, the binding agent could be distributed in the thickness of the papers to increase reactive area.

If the paper sheet comprises the additives as defined above, the additives are added to the aqueous slurry in the aqueous slurry during step a), to the aqueous slurry after step a), to the wet paper after step b) or to the paper sheet after step c).

Typically a sizing agent is applied in the aqueous slurry during step a), after step a) and before step b), or after the wet paper has been formed during step b) and prior to any significant drying during step c).

Typically, the sizing agent is added to the wet paper using bath sizing, using a size press, through spraying, through the use of a smoothing press, through the use of a gate roll size press, using calendar sizing, through blade coating, or the like. When using a size press to apply the sizing agent, the newly formed wet paper can be passed through rollers that press the sizing agent into the paper sheet and optionally remove excess additive or size.

There may be certain advantages to applying the sizing agent using a size press. For instance, the sizing agent can make the wet paper more hydrophobic and/or can improve surface strength or water resistance. In this manner, the wet paper may be more easily dewatered.

The skilled person knows how to adapt the papermaking process of the present invention for manufacturing a paper sheet as defined above and comprising a sizing agent.

Typically a humectant is applied to one surface or to both surfaces of the papers after step b) or step c), i.e. to the wet paper after step b) or to the paper sheet after step c). Any suitable technique may be used to apply the humectant to the papers. For instance, the humectant may be applied by size press, spraying, knife coating, Meyer rod coating, dusting, transfer roll coater or through any suitable printing process. Printing processes that may be used include flexographic printing, gravure printing, and the like. In one embodiment, the humectant may cover 100% of the surface area of one side or both sides of the papers.

In one embodiment, the humectant can be printed on one or both sides of the papers. The pattern may comprise alternating lines or alternating squares such as a checkerboard. In this manner, less humectant is used to coat the papers while still retaining all the benefits. For instance, the humectant may be applied to one surface of the papers so as to cover 10% to 100% surface area of the paper, in particular 20% to 90% of the surface area of the papers, more particularly 40% to 60% of the surface area of the papers. In another embodiment, the humectant could be distributed in the thickness of the papers to increase reactive area.

Typically, a selective filtration agent is applied as a sizing agent or can be topically applied to the paper sheet after step c). In this regard, the selective filtration agent can be combined with the sizing agent and applied to the wet paper and/or may be combined with the humectant or the binding agent and applied to the wet paper or the paper sheet after step c).

According to one embodiment, after step c), the paper sheet can also be shaped by being gathered; crimped; embossed and gathered; crimped, embossed and gathered; crimped, corrugated and gathered; or embossed, corrugated and gathered. Specifically, the paper can be continuously gathered laterally into rod form and cut to a desired length. Advantageously, these shaping steps can lead to the manufacture of a filter element.

The paper sheet may be crimped or embossed and/or corrugated using various techniques. The corrugation pattern can vary and can have a wavy, square wave, or saw-tooth configuration. In one embodiment, the paper sheet may be moistened prior to being embossed, crimped and/or corrugated.

### EXAMPLES

### Example 1Manufacture of Paper Sheet of the Present Invention

### Example 1-1: Paper Sheet Comprising 50% of Refined Bleached Softwood Fibers and 50% of Hydrophobic Viscose Fibers Having a Dry Basis Weight of 36 g·m⁻²

The hydrophobic viscose fibers are the DANUFIL OLEA® viscose fibers manufactured by Kelheim Fibres GmbH. These fibers have a titer of 1.7 dtex and a length of 5 mm.

Bleached softwood fibers are refined using a conventional disk refiner. The SR degree of the refined softwood fibers is 15° SR.

The refined softwood fiber and the hydrophobic viscose fibers are mixed with water to obtain an aqueous slurry. The aqueous slurry is then deposited onto a porous forming surface of an inclined wire paper machine to form a wet paper. The wet paper is then dried between 80° C. and 100° C. to obtain the paper sheet of Example 1-1.

### Example 1-2: Paper sheet comprising 40% of refined bleached softwood fibers and 60% of hydrophobic viscose fibers having a dry basis weight of 37 g·m⁻²

The hydrophobic viscose fibers are the DANUFIL OLEA® viscose fibers manufactured by Kelheim Fibres GmbH. These fibers have a titer of 3.3 dtex and a length of 5 mm.

Bleached softwood fibers are refined using a conventional disk refiner. The SR degree of the refined cellulose fibers is 15° SR.

The process is the same as described in Example 1-1.

### Example 1-3: Paper Sheet Comprising 50% of Refined Unbleached Softwood Fibers and 50% of Hydrophobic Viscose Fibers Having a Dry Basis Weight of 37 g·m⁻²

The hydrophobic viscose fibers are the DANUFIL OLEA® viscose fibers manufactured by Kelheim Fibres GmbH. These fibers have a titer of 1.7 dtex and a length of 5 mm.

Unbleached softwood fibers are refined using a conventional disk refiner. The SR degree of the refined cellulose fibers is 15° SR.

The process is the same as described in Example 1-1.

### Example 1-4: Paper Sheet Comprising 50% of Refined Bleached Softwood Fibers and 50% of Hydrophobic Viscose Fibers Having a Dry Basis Weight of 26 g·m⁻²

The hydrophobic viscose fibers are the DANUFIL OLEA® viscose fibers manufactured by Kelheim Fibres GmbH. These fibers have a titer of 1.7 dtex and a length of 5 mm.

The bleached softwood fibers are refined using a conventional disk refiner. The SR degree of the refined cellulose fibers is 15° SR.

The process is the same as described in Example 1-1, but slightly adapted to obtain the paper sheet having a basis weight of 26 g·m⁻².

### Example 1-5: Paper Sheet Comprising 49.925% of Refined Cellulose Fibers, 49.925% of Hydrophobic Viscose Fibers and 0.15% of an Additive and Having a Dry Basis Weight of 26 g·m⁻²

The bleached cellulose fibers are refined using a conventional disk refiner. The SR degree of the refined cellulose fibers is 15° SR.

The hydrophobic viscose fibers are the DANUFIL OLEA® viscose fibers manufactured by Kelheim Fibres GmbH. These fibers have a titer of 1.7 dtex and a length of 5 mm.

The same process as described in Example 1-1 is used, except that the additive (sizing agent being alkyl ketene dimer), is added by size press to the wet paper while forming the paper sheet.

### Example 1-6: Laboratory Scale Paper Sheet Comprising 50% of Cellulose Fibers and 50% of Hydrophobic Viscose Fibers and Having a Dry Basis Weight of 35 g·m⁻²

The paper sheet of Example 1-6 has been produced at a laboratory scale using laboratory equipment.

The paper sheet is made with unrefined cellulose fibers and the DANUFIL OLEA® viscose fibers manufactured by Kelheim Fibres GmbH of Example 1.

### Example 1-7: Laboratory Scale Paper Sheet Comprising 40% of Cellulose Fibers, 40% of Hydrophobic Viscose Fibers and 20% of PVA Fibers and Having a Dry Basis Weight of 35 g·m⁻²

The paper sheet of Example 1-7 has been produced at a laboratory scale using laboratory equipment.

The paper sheet is made with unrefined cellulose fibers, the DANUFIL OLEA® viscose fibers manufactured by Kelheim Fibres GmbH of Example 1 and PVA fibers having a titer of 1.1 dtex and a length of 4 mm.

### Example 1-8: Paper Sheet Comprising 50% of Refined Unbleached Softwood Fibers and 50% of Hydrophobic Viscose Fibers Having a Dry Basis Weight of 30 g·m⁻²

Kelheim Fibres GmbH. These fibers have a titer of 1.7 dtex and a length of 5 mm.

The bleached softwood fibers are refined using a conventional disk refiner. The SR degree of the refined cellulose fibers is 15° SR.

The process is the same as described in Example 1-1, but slightly adapted to obtain the paper sheet having a basis weight of 30 g·m⁻².

### Example 2—Characterisation of the Paper Sheets of Example 1

The characteristics of the paper sheets of Examples 1-1 to 1-5 are presented in Table 1 below.

All five paper sheets can be easily used to manufacture a filter element since:
the tensile strength MD of all five papers is above 2500 cN/30 mm, and
the tensile strength CD of all five papers is above 950 cN/30 mm.

Moreover, the physical properties of these five paper sheets are such that these paper sheets may be used as a filter media in a filter element.

The characteristics of the laboratory scale paper sheets of Examples 1-6 to 1-7 are presented in Table 2 below.

TABLE 1

| | Example 1-1 | Example 1-2 | Example 1-3 | Example 1-4 | Example 1-5 |
|---|---|---|---|---|---|
| Basis weight | 36 | 37 | 37 | 26 | 26 |
| (g/m²) | | | | | |
| Porosity | 18700 | 21500 | 11000 | 24600 | 16900 |
| (Coresta) | | | | | |
| Tensile strength MD | 3110 | 2690 | 3200 | 2500 | 2830 |
| (cN/30 mm) | | | | | |
| Tensile strength CD | 1600 | 1075 | 1200 | 990 | 1120 |
| (cN/30 mm) | | | | | |

TABLE 2

| | Example 1-6 | Example 1-7 |
|---|---|---|
| Basis weight (g/m²) | 35.4 | 35.5 |
| Thickness (μm) | 156 | 145 |
| Porosity (Coresta) | 30500 | 14000 |

The characteristics of the paper sheet of example 1-8 are:

Basis weight: 31 g/m²; porosity: 15900 Coresta, Tensile strength MD: 2150 cN/30mm; Tensile strength CD: 900 cN/30mm; Thickness:91 μm

### Example 3—Characterisation of the Hydrophobic Properties of the Paper Sheets of Example 1 and of Comparative Paper Sheets

### Comparative Examples 3-1 to 3-4

Comparative Example 3-1: paper sheet comprising 100% unrefined softwood fibers; basis weight: 36 g/m²
Comparative Example 3-2: paper sheet comprising 50% refined softwood fibers having a SR degree of 15° SR and 50% viscose fibers; basis weight: 36 g/m²
Comparative Example 3-3: paper sheet comprising 50% of refined softwood fibers having a SR degree of 15° SR and 50% cellulose acetate fibers; basis weight: 36 g/m²
Comparative Example 3-4: non woven cellulose acetate fibers sheet; basis weight: 25 g/m²

### Characterization of the Hydrophobic Properties

The hydrophobic properties of the paper sheets of Example 1-1 to 1-5 and 1-8 and Comparative Examples 3-1 to 3-4 are presented in Table 3 below.

TABLE 3

| | Capillarity Rise | Water Drop | Water contact angle |
|---|---|---|---|
| | (mm/10 min) | (s) | (°) |
| Examples | | | |
| 1-1 | 0 | >180 | 94 |
| 1-2 | 0 | >180 | 116 |
| 1-3 | 0 | >180 | 103 |
| 1-4 | 0 | >180 | 84 |
| 1-5 | 0 | >180 | not measured |
| 1-8 | 0 | >180 | 110 |
| comparative | | | |
| examples | | | |
| 3-1 | 96 | <2 | <15 |
| 3-2 | 129 | <1 | <15 |
| 3-3 | 81 | <2 | <15 |
| 3-4 | 0 | >180 | 89 |

The Capillary Rise of the paper sheet is measured by ISO 8787:1986.

Water drop corresponds to the time necessary for a drop of water to be absorbed by the paper sheet as measured by TAPPI T432 of 1964.

The water contact angle is determined as described above.

The paper sheets of Comparative Examples 3-1 to 3-3 are hydrophilic.

In the contrary the paper sheets of Examples 1-1 to 1-5 and 1-8 have a water contact angle higher than 80. These paper sheets are hydrophobic.

As presented in Table 3, the introduction of the hydrophobic viscose fibers in the paper sheet makes the paper sheet hydrophobic such as Comparative Example 3-4 (100% cellulose acetate fibers).

By comparing the Comparative Examples 3-1 to 3-3, it can be seen that the introduction of cellulose acetate or of viscose fibers does not make the paper sheet hydrophobic.

### Example 4—Filter element made of the paper sheet of Example 1-1

A filter element made of the paper sheet of Example 1-1 is manufactured. This filter element is combined to a tobacco rod to form a cigarette.

A filter element made of the paper sheet of Comparative Example 3-1 is manufactured. This filter element is combined to a tobacco rod to form a cigarette.

The two cigarettes are tested by sensory experts.

The filter element made of the paper sheet of Example 1-1 has excellent filtration properties and produces a smoke having a superior sensory appreciation comparing to the filter element made of the paper sheet of Comparative Example 3-1. In particular the smoke produced by the filter element made of the paper sheet of Example 1-1 has less harsh and dry taste.

1. A paper sheet comprising cellulose fibers and hydrophobic fibers, wherein the cellulose fibers represent 10% to 90% by weight of the dry matter of the paper sheet, the hydrophobic fibers represent 10% to 90% by weight of the dry matter of the paper sheet and the cellulose fibers and the hydrophobic fibers represent at least 50% by weight of the dry matter of the paper sheet.

2. The paper sheet according to claim 1, wherein
the hydrophobic fibers represent at least 30% by weight of the dry matter of the paper sheet and the cellulose fibers and the hydrophobic fibers represent at least 70% by weight of the dry matter of the paper sheet.

3. The paper sheet according to claim 1, wherein the weight ratio of hydrophobic fibers to cellulose fibers is 2:3 to 3:2.

4. The paper sheet according to claim 1, wherein the hydrophobic fibers are hydrophobic viscose fibers.

5. The paper sheet according to claim 4, wherein
the hydrophobic viscose fiber is a resulting mixture of a viscose fiber and a hydrophobic substance selected from the group consisting of alkyl ketene dimers, alkenyl ketene dimers, alkyl succinic anhydrides, alkenyl succinic anhydrides, alkyl glutaric acid anhydrides, alkenyl glutaric acid anhydrides, alkyl isocyanates, alkenyl isocyanates, fatty acid anhydrides, and mixtures thereof, and the content of the hydrophobic substance in the hydrophobic viscose fiber is 0.1% by weight to 13% by weight based on viscose fiber.

6. The paper sheet according to claim 1, wherein the cellulose fibers are refined and have a Shopper-Riegler degree (SR degree) of 9° SR to 90° SR.

7. The paper sheet according to claim 1, further comprising a binding agent.

8. The paper sheet according to claim 7 wherein the binding agent has a shape of fiber and, preferably is chosen from polyvinyl alcohol fibers, polyvinyl acetate fibers, polyethylene fibers, polypropylene fibers, polyester fibers, cellulose acetate fibers, nylon, cellulose ester fiber and mixture thereof.

9. The paper sheet according to claim 1, having a water contact angle higher than 70°.

10. The paper sheet according to claim 1, having a capillary rise according to ISO 8787:1986 below 10 mm/10 min.

11. The paper sheet according to claim 1, having a basis weight of 15 g·m⁻² to 60 g·m⁻².

12. The paper sheet according to further comprising an additive.

13. Forming the paper sheet as defined in claim 1 into a filter element.

14. A filter material comprising the paper sheet as defined in claim 1.

15. A papermaking process for manufacturing a paper sheet as defined in claim 1 comprising the following steps:
a) mixing the cellulose fibers, hydrophobic fibers and water to obtain an aqueous slurry;
b) forming the aqueous slurry into a wet paper on an inclined wire paper machine or flat wire paper machine, and
c) drying the wet paper to obtain the paper sheet.

16. The papermaking process of claim 15 for manufacturing a paper sheet wherein, before step a), the cellulose fibers are refined so as to have a SR degree of 9° SR to 90° SR.

17. The papermaking process of claim 15 for manufacturing a paper sheet wherein the binding agent is added to the aqueous slurry during or after step a), is applied to one surface or to both surfaces of the wet paper after step b) or to the paper sheet after step c).

18. The papermaking process of claim 15, wherein, during step c), the wet paper is dried at a temperature of 60° C. to 175° C.

19. The papermaking process of claim 15, wherein, after the step c), the paper sheet is also shaped by being:
gathered;
crimped;
embossed and gathered;
crimped, embossed and gathered;
crimped, corrugated and gathered; or
embossed, corrugated, and gathered.
